(19) United States
(12) Patent Application Publication
(10) Pub. No.: US 2012/0040583 A1
(43) Pub. Date: Feb. 16, 2012

(54) FIRE-LIGHTER

(76) Inventor: Juergen Heumueller, Geiselwind-Wasserberndorf (DE)

(21) Appl. No.: 13/265,409

(22) PCT Filed: Apr. 21, 2010
(86) PCT No.: PCT/EP2010/055251

§ 371 Date: Oct. 20, 2011

(30) Foreign Application Priority Data
Apr. 21, 2009 (DE) 20 2009 005 902.2

(51) Int. Cl. B32B 21/10; D04H 13/00

(52) U.S. Cl. 442/413; 442/327

(57) ABSTRACT

A fire-lighter, comprising a non-woven fabric composite produced by compression and made of a combustible fiber material of a fiber material mixture and a combustible binder, which wets and/or soaks the fiber material or the fiber material mixture and is substantially solid at room temperature and is liquid near the flash point.

The invention relates to a kindling aid. Kindling aids are materials to facilitate the kindling of actual fire fuels, for example coal briquettes or wood. For this, kindling aids are generally set alight and pushed alight under the fire fuel. Kindling aids have to be easy to set alight, but they must also burn slowly and continuously to achieve a uniform increase in temperature until flashpoint in the actual fire fuel.

Wood wool or some other fibrous material, for example paper, is very often used as kindling aid. Materials of this type have a relatively low flashpoint and hence are comparatively easy to ignite. However, they burn out relatively quickly within the entire and relative loose volume before the surrounding fire fuel has reached its flashpoint and hence caught fire. The amount of kindling aid applied accordingly has to be quite large to achieve kindling of the fire fuel. This results in comparatively high material requirements.

It is an object of the present invention to specify a kindling aid that uses a fibrous material and that has a low flashpoint, shows a very slow, controllable burn and is capable of ensuring an intensive transfer of heat to the surrounding fire fuel.

This object is achieved by a kindling aid having the features of claim 1, while dependent claims relate to advantageous refinements.

The kindling aid according to the invention consists of a fibrous nonwoven web assembly produced by densifying and comprised of a combustible fibrous material and a combustible binder that saturates the fibrous material and is solid at room temperature and liquid in the vicinity of the flashpoint.

The combustible fibrous material ensures ready ignitability and facilitates the kindling of the kindling aid. The binder occludes the cavities left between the fibers. The compressed state of the assembly formed as a result ensures that the kindling aid burns on its surface only, the burning thereof being slow and sustained. The binder stabilizes the assembly, but also ensures that the kindling aid when alight assumes a plastically deformable, flowable form, while the burning binder is released onto the surrounding fire fuel to remain there and additionally contribute to igniting the fire fuel.

In one advantageous embodiment, the combustible fibrous material consists of wood wool fibers. Wood has a comparatively ready ignitability and on burning produces a sufficiently large heat of combustion, which is certain to ignite the surrounding fire fuel.

In a further advantageous embodiment, the binder is a wax. Waxes have a slow burn, exhibit very good bondability in respect of the fibrous nonwoven web assembly at room temperature and, when the temperature is increased, melt before the flashpoint is reached, causing the assembly to change shape and come into contact with the surrounding fire fuel.

Advantageously, the fibrous nonwoven web assembly is in sheet form. This form is particularly simple to produce, can readily be further processed and is simple to push under the fire fuel.

In one particularly advantageous embodiment, the fibrous nonwoven web assembly has a diamond-shaped cut. This cut facilitates the kindling and pushing under of the kindling aid. The diamond shape can be held at one of the pointed corners and be kindled at the pointed corner opposite. The pointed burning corner is by virtue of its wedge shape easy to push into the fire fuel and develops an optimum heating effect there.

In one preferred embodiment, the fiber material, or a mixture of fiber materials, is densified by the method of jet consolidation which is known as water jet consolidation in the field of textile nonwovens. According to the invention, however, it is not water which is used as force-introducing means, but a paraffin or a wax jet which via a nozzle arrangement acts on the fibers under high pressure. When the fibrous materials are supplied via a carding zone in cross-laid form for example, the density of the end product can be varied between wide limits. The paraffin or water jet performs a dual function in that the fibers are consolidated and, on the other hand, the necessary wetting of the fibrous material as igniting means is ensured.

Any densities can be realized starting from a quasi airily loose structure up to and including a comparatively high degree of densification. When an airily loose structure is retained, the result is particularly easy kindling and a faster burn with high evolution of heat. When a longer burn time is desired, the degree of densification can be increased by reducing the air cavities or interstices. And it is not necessary in principle that, as described in the preceding exemplary embodiment, all the cavities have to be filled with binder.

In a further embodiment of the invention, the fibrous nonwoven web assembly can initially be introduced in sheet or ribbon form and later be further processed into a wound package.

The fibrous material is preferably a material composed of wood wool fibers, or else a material based on fibers from planing wastes, cortex or bark.

The kindling aid will now be more particularly elucidated by means of exemplary embodiment.

To fabricate the assembly, the initial step is to drench wood wool fibers in a liquid wax by dipping or drizzling combined with circulating or turning over the fibers. The wax used is essentially one of the substances defined by the German Society for Fat Science's DGF Standard Method M-I 1 (75). These are kneadable and have a solid or frangibly hard constitution at 20° C. only to transition, without decomposing, into a flowable or liquid state of low viscosity at more than 40° C. Lipid-based animal waxes can be used, especially spermaceti or beeswax. But vegetable waxes can also be used, especially sugarcane wax or carnauba wax. Another possibility is to use so-called earth waxes, or the ceresin produced therefrom. Finally it is naturally also possible to use synthetically produced waxes based on paraffin, such as stearin in particular.

The wood fibers thus drenched are laid down on a feeding means for a continuous press. The continuous press can be embodied not only as a single-platen press but also as a multi-platen press, which can also be operated as a short cycle press. The wax-drenched wood fibers fed by the feeding means into the press are introduced between heatable platens and compressed under heat and pressure. The platens are heated via hot water or via an electrical heating means. The wax heats up, melts and resolidifies after passing through the press, resulting in the production of a solid and dense, sheet-shaped fibrous nonwoven web assembly comprising interadhered wood wool fibers.

The density of the sheets produced depends essentially on the molding pressure, while the thickness of the sheets produced is determined by the supplied volume of drenched wood wool. It will be advantageous to use in particular a sheet thickness in the range from 1 to 4 centimeters and preferably between 2 and 3 centimeters.

Sheet production is followed by an individualizing operation. Individualization is advantageously effected by cutting or die-cutting.

This produces diamond-shaped pieces of the fibrous nonwoven web assembly. The diamond-shaped pieces have a diagonal length of about 7 to 11 cm in the large diagonal and 1 to 4 cm in the small diagonal. A length of 9 cm and 2.5 cm respectively will be found to be particularly advantageous. Fibrous nonwoven web remnants remaining after the cutting or die-cutting operation can be heated and sent anew through the continuous press.

To use the fibrous nonwoven web assembly, the diamond shape described is conveniently kindled at one of the pointed corners. Owing to the dense consistency of the fibrous nonwoven web assembly, the wood wool drenched with the wax burns slowly and evenly. The wax escapes in the process and likewise reaches its ignition temperature a short time later. Very shortly after the kindling of the fibrous nonwoven web, the diamond with the burning tip is pushed into the available fire fuel, for example briquettes. During the slow burning of the fibrous nonwoven web, the fire fuel heats up and is maintained at this temperature for a prolonged period until finally its own combustion ensues. The fibrous nonwoven web softens in the process and wets the fire fuel, while the increasing temperature now also causes ignition of the melting wax wetting the fire fuel, furthering the ignition of the fire fuel in a particular manner.

In a further exemplary embodiment of the invention, wood wool fibers having a suitable fiber length in the range from several millimeters to centimeters are prepared and laid crosswise and fed to a water jet consolidation rig to form a multilayered fibrous nonwoven web. This water jet consolidation rig, however, employs a liquid or liquefied fire fuel, preferably based on wax or paraffin, as energy medium and not water. After passing through the jet consolidation rig, the fibrous nonwoven web material obtained has a predetermined density and strength after the paraffin or wax material has cooled down and solidified.

In this embodiment, the liquefied combustible material fulfills not only the office of fibrous nonwoven web consolidation but also the purpose of wetting or partially drenching the fibers to ensure the desired properties for the kindling means according to the invention.

The fibrous nonwoven web material can, if desired, be subjected to a further densification, for example using a continuous press, after jet consolidation. It is similarly possible to form a wound package which is later separated into individual elements in order to create quasi disk-shaped ignition aids or ignition aids in the form of a tubular wound package.

1. A kindling aid comprising a fibrous nonwoven web assembly produced by densifying and comprised of a combustible fibrous material or a fibrous material mixture and a combustible binder that wets and/or saturates the fibrous material or the fibrous material mixture and is essentially solid at room temperature and liquid in the vicinity of the flashpoint.

2. The kindling aid as claimed in claim 1, wherein the combustible fibrous material consists of wood wool fibers, fibers from planing wastes and/or cortex or bark fibers.

3. The kindling aid as claimed in claim 1, wherein the saturating binder is a paraffin or wax or the like with corresponding flashpoint.

4. The kindling aid as claimed in claim 1, wherein the fibrous nonwoven web assembly is in sheet form.

5. The kindling aid as claimed in claim 1, wherein the fibrous nonwoven web assembly is configured as a diamond-shaped blank.

6. The kindling aid as claimed in claim 1, wherein the densifying is effected by jet consolidation.

7. The kindling aid as claimed in claim 6, wherein the fibrous nonwoven web assembly is produced by paraffin or wax jet consolidation, wherein the fibrous material is cross-laid in one or more layers.

8. The kindling aid as claimed in claim 1, wherein the fibrous nonwoven web assembly is of low density with air inclusions, wherein the degree of density and the proportion of fibrous material to combustible binder can be used to predetermine the burn time and the heat evolution during burning.

9. The kindling aid as claimed in claim 1, wherein the fibrous nonwoven web assembly is configured as a wound package produced from a sheet or a ribbon.
